(19) United States
(12) Patent Application Publication
(10) Pub. No.: US 2026/0357554 A1
(43) Pub. Date: Nov. 12, 2026

(54) DRAIN CLEANING DEVICE AND CABLE OILING SYSTEM

(71) Applicant: MILWAUKEE ELECTRIC TOOL CORPORATION, Brookfield, WI (US)

(72) Inventors: Katherine G. Stuart, East Peoria, IL (US); Dale J. Reiff, Columbia City, IN (US); Diekololaoluwa O. Ande, Simi Valley, CA (US); Owen D. Austin, Robinson, IL (US); Ryan J. Denissen, Sussex, WI (US)

(21) Appl. No.: 19/663,584

(22) Filed: Apr. 30, 2026

Related U.S. Application Data
(60) Provisional application No. 63/803,220, filed on May 9, 2025.

(51) Int. Cl. E03C 1/302; F16N 7/00

(52) U.S. Cl. CPC E03C 1/302; F16N 7/00; F16N 2210/34; F16N 2280/00

(57) ABSTRACT

A drain cleaning device includes a frame and a drum assembly supported by the frame configured to rotate about an axis of rotation. The drain cleaning device includes a motor supported by the drum assembly. The motor includes an output shaft. The drain cleaning device includes a flexible cable stored within the drum assembly. The flexible cable defining a first end, a second end opposite the first end, a sheath extending between the first end and the second end, and a wound cable positioned within the sheath, the first end coupled to the output shaft to receive torque from the motor. The first end includes an aperture that extends into the sheath. The drain cleaning device includes a cable oiling system supported by the drum assembly adjacent the first end of the cable to supply oil to a space between the wound cable and the sheath through the aperture.

### CROSS-REFERENCE TO RELATED APPLICATION

This application claims priority to co-pending U.S. Provisional Patent Application No. 63/803,220, filed May 9, 2025, the entire contents of which are incorporated by reference herein.

### FIELD OF THE DISCLOSURE

The present application relates to drain cleaning devices for cleaning drains, pipes, or other conduits, and specifically, to a flexible shaft drain cleaner.

### BACKGROUND OF THE DISCLOSURE

Flexible shaft drain cleaners are known as high-speed drain cleaners because they include motors that spin the cable at higher speeds. The higher speed is produced by directly driving the cable with torque from a motor/drive mechanism. In addition, flexible shaft drain cleaners include an improved cable to withstand the higher speeds. Flexible shaft cables are different from traditional drain cleaner cables and typically include a wound cable driven by the motor that is encased by a sheath. Oil is typically supplied between the cable and the sheath to reduce friction between the sheath and cable while the cable rotates inside the sheath.

### SUMMARY OF THE DISCLOSURE

In some aspects, the techniques described herein relate to a drain cleaning device including: a frame; a drum assembly supported by the frame, the drum assembly configured to rotate about an axis of rotation; a motor supported by the drum assembly, the motor including an output shaft; a flexible cable stored within the drum assembly, the flexible cable defining a first end, a second end opposite the first end, a sheath extending between the first end and the second end, and a wound cable positioned within the sheath, the first end coupled to the output shaft to receive torque from the motor, the first end including an aperture that extends into the sheath; and a cable oiling system supported by the drum assembly adjacent the first end of the cable to supply oil to a space between the wound cable and the sheath through the aperture.

In some aspects, the techniques described herein relate to a cable oiling system for a drain cleaning device including a flexible cable with a sheath and a wound cable positioned within the sheath, the cable oiling system including: a housing defining a cable inlet, a cable outlet, and a reservoir therebetween, the reservoir configured to store oil; and a valve supported by the cable inlet, the valve including a first portion, a second portion extending from the first portion and into the reservoir, and a bore extending between the first and second portions, the flexible cable configured to extend through the cable inlet, the cable outlet, and the bore; wherein the valve is moveable from a first position, in which oil is distributed to the wound cable from the reservoir, and a second position, in which the distribution of oil from the reservoir to the wound cable is inhibited.

Other aspects of the invention will become apparent by consideration of the detailed description and accompanying drawings.

### BRIEF DESCRIPTION OF THE DRAWINGS

FIG. 1 is a front perspective view of a drain cleaning device.

FIG. 2 is a rear perspective view of the drain cleaning device of FIG. 1.

FIG. 3 is a front perspective view of the drain cleaning device of FIG. 1 with portions removed.

FIG. 4 is a cross-sectional view of the drain cleaning device of FIG. 1.

FIG. 5 is a rear perspective view of the drain cleaning device of FIG. 1 with portions removed.

FIG. 6 is a perspective view of the drain cleaning device of FIG. 1 illustrating a method of oiling a drain cleaning cable.

FIG. 7 is a perspective view of a cable oiling system for use with the drain cleaning device of FIG. 1.

FIG. 8 is a cross-sectional view of the cable oiling system of FIG. 7.

FIG. 9 is a top view of a bottom housing of the cable oiling system of FIG. 7.

FIG. 10 is a perspective view of the bottom housing of FIG. 9.

FIG. 11 is a perspective view of a valve of the cable oiling system of FIG. 7.

FIG. 12 is a top view of the cable oiling system of FIG. 7.

FIG. 13 is a schematic drawing of a flow path of the cable oiling system of FIG. 7.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

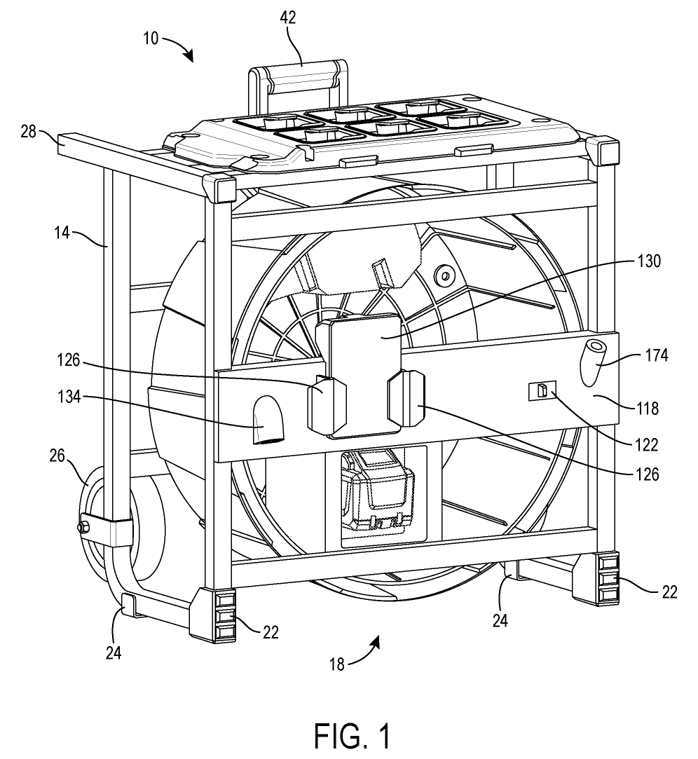

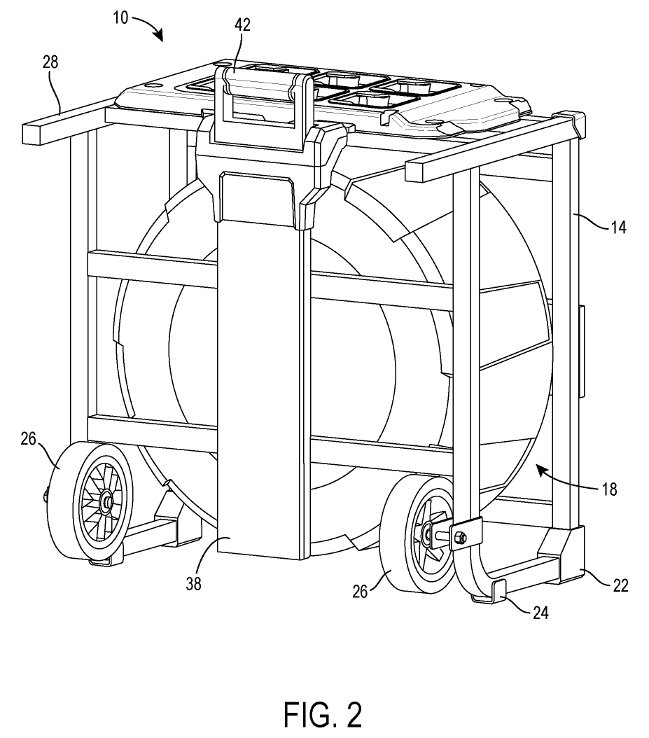

FIGS. 1 and 2 illustrate a drain cleaning device 10 that is operable to clear and clean debris from pipes or other conduits. The illustrated drain cleaning device 10 is one example of a drain cleaning device. In other embodiments, the drain cleaning device 10 may have other components or configurations. In the illustrated embodiment, the drain cleaning device 10 is a flexible shaft drain cleaner. The drain cleaning device 10 is operable to spin a drain cleaning cable at a relatively high speed. As described below, the drain cleaning cable may include a wound cable, or other suitable cable, positioned within a sheath. The wound cable is driven (e.g., spun) by the drain cleaning device 10 within the sheath to clear debris from a conduit.

The illustrated drain cleaning device 10 includes a frame 14 and a drum assembly 18 supported by the frame 14. The frame 14 is made from a plurality of bars or links that are coupled together through welding, fasteners, or the like to form a cage-like structure around the drum assembly 18. The frame 14 includes a pair of rubber grommets 22 on a front side and a pair of feet 24 to help stabilize the drain cleaning device 10 when the drain cleaning device 10 is in an upright position, as shown in FIG. 1. Wheels 26 are coupled to a back side of the frame 14 to facilitate transporting the drain cleaning device 10 across a surface. For example, the drain cleaning device 10 may be tipped onto the wheels 26 (and off of the grommets 22 and feet 24) to move the drain cleaning device 10 along the ground. The drain cleaning device 10 may also be tipped completely onto the wheels 26 and legs 28 of the frame 14 to position the drain cleaning device 10 in a horizontal, operating position.

As shown in FIG. 2, a handle 42 is coupled to the frame 14 to facilitate transporting the drain cleaning device 10. The handle 42 is slidable between a retracted position (FIG. 2) and an extended position. Once the handle 42 is in the extended position, a user may tilt the drain cleaning device 10 onto the wheels 26 and transport the drain cleaning device 10 to a new location.

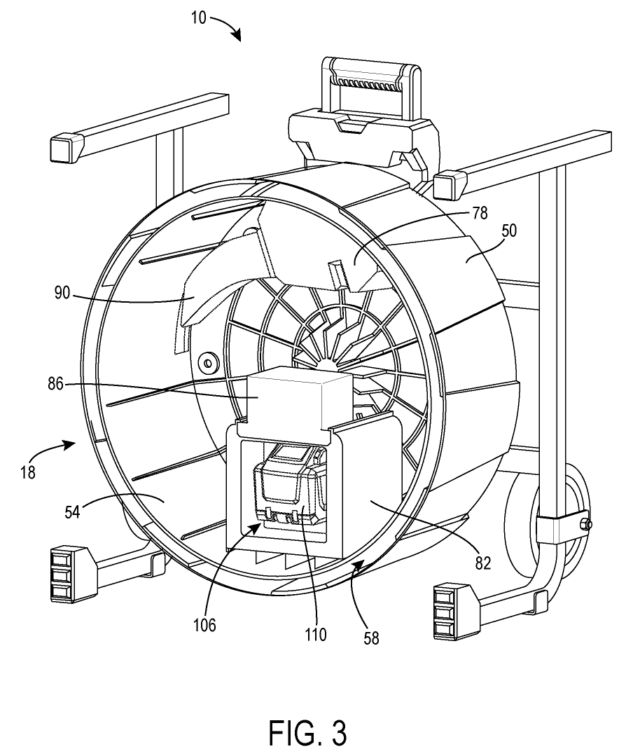

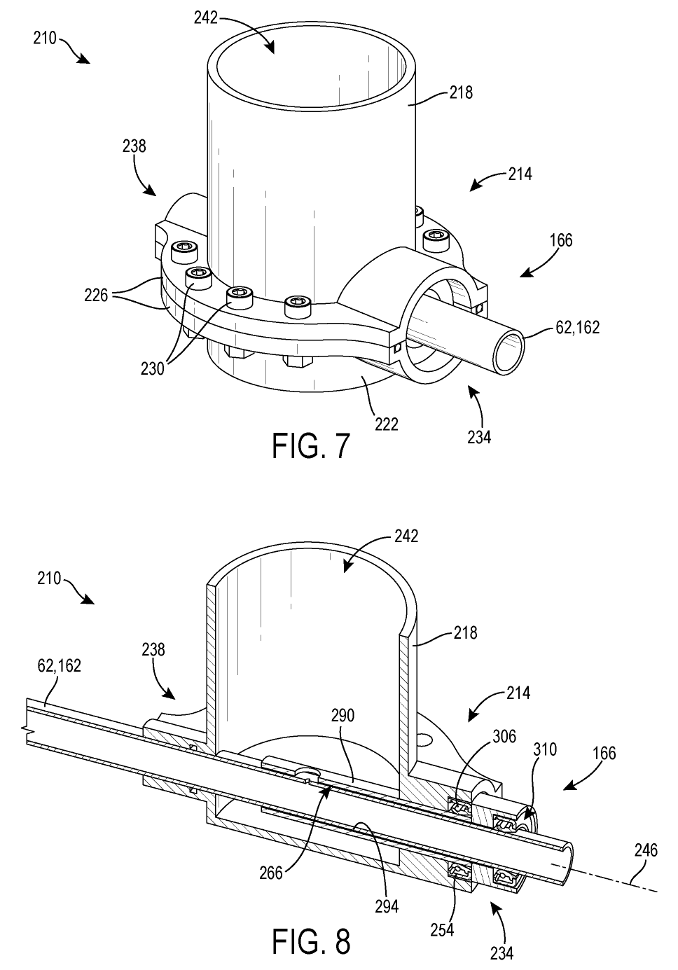

With reference to FIG. 3, the illustrated drum assembly 18 includes an outer drum 50 and an inner drum 54 coupled to the outer drum 50 for co-rotation therewith. In the illustrated embodiment, the outer and inner drums 50, 54 are cylindrical-shaped with an open front end and a closed rear end. In other embodiments, the inner and outer drums 50, 54 may be enclosed to define an interior. In further embodiments, the drum assembly 18 may further include a drum housing that surrounds the inner and outer drums 50, 54. The inner drum 54 has a smaller diameter than the outer drum 50 to define a space 58 therebetween. A drain cleaning cable 62 (FIG. 7) may be supported within the space 58, as described in more detail below.

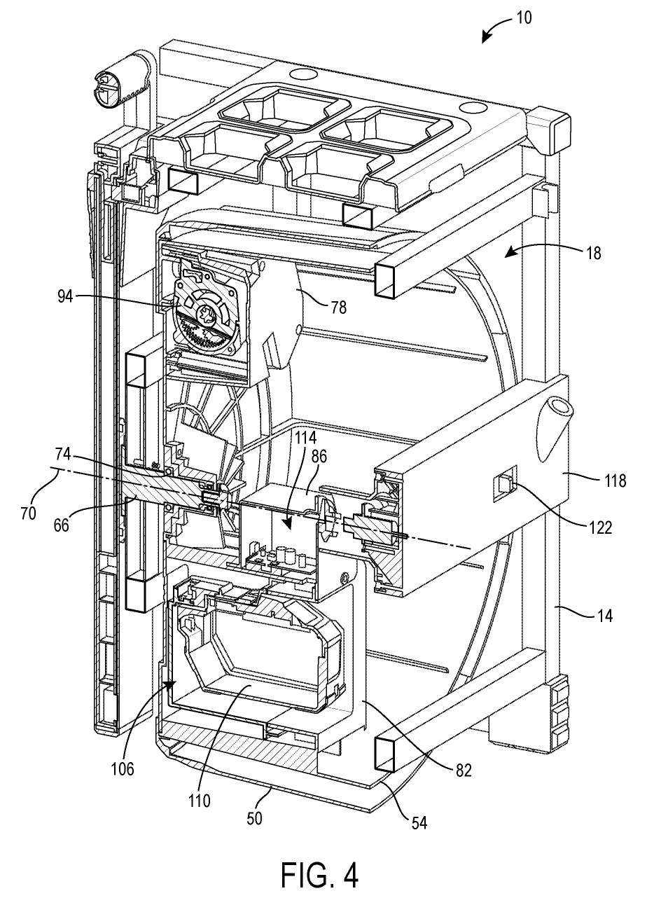

As shown in FIG. 4, the drum assembly 18 is supported on the frame 14 by a support shaft 66. The support shaft 66 includes a first end that is coupled to the frame 14 and a second end that is coupled to the inner drum 54. The support shaft 66 defines an axis of rotation 70 of the drum assembly 18. A bearing 74 is positioned between the inner drum 54 and the support shaft 66 to allow rotation of the inner drum 54 relative to the support shaft 66. In the illustrated embodiment, the drum assembly 18 is idly supported on the support shaft 66. In other words, the drum assembly 18 is allowed to freely rotate on the support shaft 66. In other embodiments, the drum assembly 18 may be driven by a motor to rotate with or about the support shaft 66.

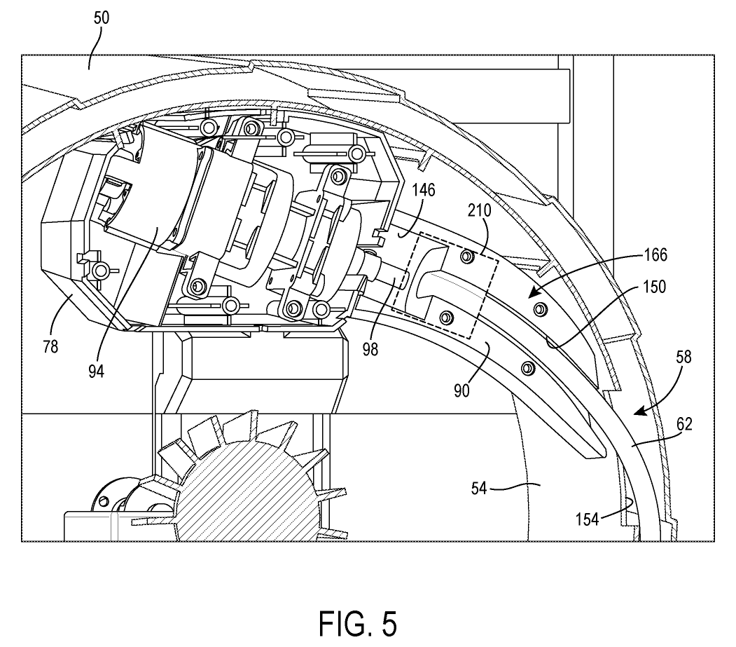

Referring to FIGS. 3 and 4, the inner drum 54 supports a motor housing 78, a battery housing 82, an electronics housing 86, and a cable guide housing 90. A motor 94 is supported within the motor housing 78. In some embodiments, the motor 94 may be a DC brushless motor. In other embodiments, the motor 94 may include a brush. As shown in FIG. 5, the motor 94 includes an output shaft 98 that is configured to be directly coupled to the drain cleaning cable 62 to rotate the cable 62.

With continued reference to FIGS. 3 and 4, the battery housing 82 defines a battery receptacle 106 configured to receive a battery pack 110. In the illustrated embodiment, the battery receptacle 106 is positioned on a diametrically opposite side of the axis of rotation 70 from the motor 94. The battery pack 110 may include any of number of different nominal voltages (e.g., 12V, 18V, etc.), and may be configured having any of number of different chemistries (e.g., lithium-ion, nickel-cadmium, etc.). The battery pack 110 is operable to supply power to the motor 94 to energize the motor 94. The battery pack 110 is a removable battery pack. The battery pack 110 is also a rechargeable battery pack. Alternatively, the motor 94 may be powered by a remote power source (e.g., a household electrical outlet) through a power cord. In the illustrated embodiment, the battery pack 110 is inserted into the battery receptacle 106 in a direction that is parallel to the axis of rotation 70. As such, the battery pack 110 is mounted with its longitudinal axis parallel with the axis of rotation 70. In other embodiments, the battery pack 110 may be inserted into the battery receptacle 106 in a direction that is perpendicular or oblique to the axis of rotation 70. The battery housing 82 surrounds the battery pack 110 to inhibit fluids or other debris that may be expelled during operation of the drain cleaning device 10 from tampering with the battery pack 110.

Referring to FIG. 4, control electronics 114 are disposed within the electronics housing 86. The control electronics 114 may include a controller or processor that controls operation of the drain cleaning device 10. In some embodiments, the controller is implemented as a microprocessor with separate memory. In other embodiments, the controller may be implemented as a microcontroller (with memory on the same chip). In other embodiments, the controller may be implemented using multiple processors. In addition, the controller may be implemented partially or entirely as, for example, a field –programmable gate array (FPGA), an application specific integrated circuit (ASIC), and the like, and the memory may not be needed or be modified accordingly. The memory may include non-transitory, computer readable memory that stores instructions that are received and executed by the controller to carry out functionality of the drain cleaning device 10 described herein. The memory may include, for example, a program storage area and a data storage area. The program storage area may include combinations of different types of memory, such as read-only memory and random-access memory.

With reference back to FIG. 1, a control panel 118 is supported on the frame 14. The illustrated control panel 118 is positioned in front of the drum assembly 18. The control panel 118 includes a user interface 122. The user interface 122 may include, for example, a control switch or other suitable actuators. The user interface 122 may be selectively actuated to control operation of the drain cleaning device 10. For example, a user may toggle the user interface 122 to change the rotation direction of the output shaft 98 when the motor 94 is energized. Additionally, the user interface 122 may be a master power switch to turn the drain cleaning device 10 on and off. In other embodiments, the user interface 122 may control other operations of the drain cleaning device 10. The illustrated control panel 118 also includes clip 126 to support a foot pedal 130. Although not shown, a power cord may be coupled at one end to the foot pedal 130 and at another end to an outlet 134 on the control panel 118. The foot pedal 130 is removable from the control panel 118 to allow a user to remotely activate and control the drain cleaning device 10 (e.g., near an opening through which the cable 62 is inserted).

With reference to FIG. 5, the guide housing 90 is coupled to the inner drum 54 adjacent the motor housing 78. The guide housing 90 defines a cavity 146 and a guide channel 150 extending from the cavity 146. The output shaft 98 of the motor 94 extends from the motor housing 78 into the cavity 146 in a direction that is aligned with the guide channel 150. The guide channel 150 terminates adjacent an opening 154 in the inner drum 54 that extends into the space 58 defined between the inner and outer drums 50, 54.

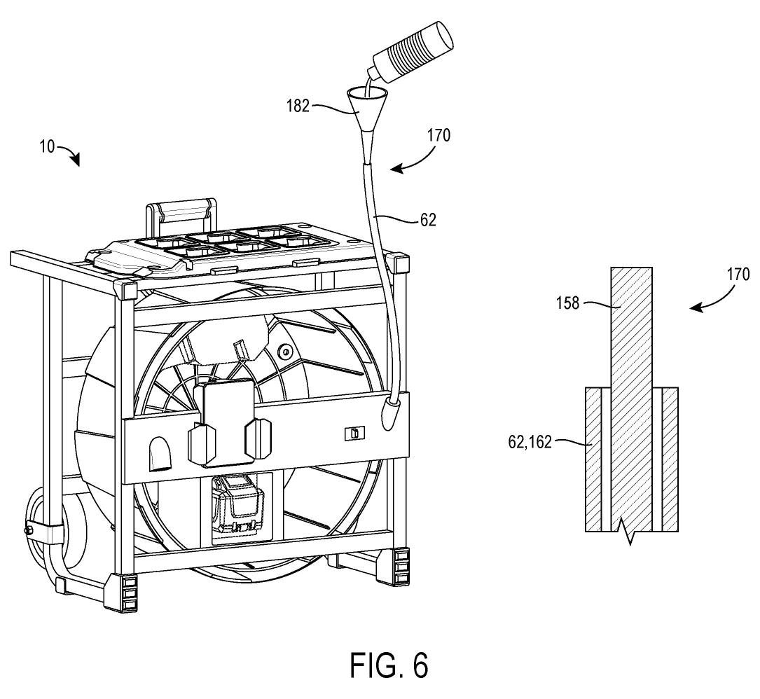

In the illustrated embodiment, the drain cleaning cable 62 is also known as a flexible shaft cable. Compared to typical drain cleaning cables, the flexible shaft cable 62 includes a wound cable 158 that is encased by a sheath 162 (FIG. 6). The wound cable 158 is operable to be rotated by the motor 94 within the sheath 162. The flexible shaft cable 62 includes a first end 166 (FIG. 5) that is coupled to the motor 94 and a second end 170 (FIG. 6) that is operable to be extended into a drain to facilitate clearing the drain. Specifically, the wound cable 158 is directly coupled to the output shaft 98 of the motor 94 at the first end 166 of the cable 62 to rotate the wound cable 158 within the sheath 162. As such, the first end 166 of the cable 62 is a drive end and the second end 170 of the cable 62 is a driven end. The portion of the cable 62 between the first and second ends 166, 170 extends from the output shaft 98 through the guide channel 150 and the opening 154 in the inner drum 54 to be coiled within the space 58 between the inner and outer drums 50, 54. The second end 170 of the cable 62 extends from the space 58 and through an outlet tube 174 (FIG. 1) disposed on the control panel 118. The outlet tube 174 assists a user in directing the cable 62 into a conduit. The outlet tube 174 may also support the second end 170 of the cable 62 when the drain cleaning device 10 is not in use. Specifically, a cable accessory (not shown) may be removably coupled to the second end 170 of the cable 62 and may rest on top of the outlet tube 174.

During operation of the drain cleaning device 10, a user may extend the second end 170 of the cable 62 into a drain or other conduit. As the cable 62 is payed out from the drum assembly 18, the drum assembly 18 rotates in a first direction. Once the second end 170 of the cable 62 encounters a clog, the user may depress the foot pedal 130 to activate the motor 94 and rotate the wound cable 158 within the sheath 162. As the wound cable 158 rotates, the cable accessory 178 assists in removing the debris or clog. Alternatively, a user may force the second end 170 of the cable 62 past the debris within a drain first before activating the motor 94. Then, the user may depress the foot pedal 130 to activate the motor 94 while retracting the cable 62 out of the drain. The motor 94 rotates the wound cable 158 and thus the cable accessory to remove the debris or clog. While the cable 62 is being retracted from the drain, the drum assembly 18 rotates in a second direction, opposite the first direction, to wind the cable 62 back within the space 58. Once the drain has been sufficiently removed of debris and clogs, the user can then retract the cable 62 from the drain to store the cable 62 within the drum assembly 18.

Due to the output shaft 98 of the motor 94 directly driving the wound cable 158 to rotate within the sheath 162, a high amount of friction may be generated. Oil, such as a 5W-40 oil, is used to lubricate the space between the wound cable 158 and the sheath 162 to improve the performance and increase the life of the cable 62. As shown in FIG. 6, to oil the cable 62 a funnel 182 may be positioned at or coupled to the second end 170 of the cable 62. A user then pours a recommended amount of oil into the funnel 182 allowing the oil to flow into the space between the sheath 162 and the wound cable 158. In order to spread the oil the length of the cable 62, a user may rotate the wound cable 158 in a reverse direction which causes the oil to flow from the second end 170 of the cable 62 towards the first end 166, similar to an Archimedes screw. However, users often leave the drain cleaning device 10 operating in reverse after adding the oil. Running the cable 62 in reverse while putting it under load (e.g., clearing debris within a drain) may unravel the fibers of the wound cable 158.

Alternatively, as shown in FIGS. 7 and 8, a cable oiling system 210 may be used to feed oil into the space between the wound cable 158 and the sheath 162. Specifically, the cable oiling system 210 is operable to feed oil into the space between the wound cable 158 and the sheath 162 from the first end 166 of the cable 62 to the second end 170 of the cable 62. As such, reversing the rotation direction of the wound cable 158 is unnecessary, reducing the possibility of a user damaging the cable 62. In the illustrated embodiment, the cable oiling system 210 is coupled to the inner drum 54 adjacent the first end 166 of the cable 62 (FIG. 5). Specifically, the cable oiling system 210 is coupled to the inner drum 54 between the output shaft 98 of the motor 94 and the guide housing 90. In other embodiments, the cable oiling system 210 may be positioned elsewhere on the drain cleaning device 10 adjacent the first end 166 of the cable 62. In further embodiments, the cable oiling system 210 may be incorporated into the cable guide housing 90. In addition, the cable oiling system 210 is positioned in the inner drum 54 so that a user can access the cable oiling system 210.

With continued reference to FIGS. 7 and 8, the cable oiling system 210 includes a two-piece housing 214 having a top housing 218 and a bottom housing 222. The top and bottom housings 218, 222 include flanges 226 that receive fasteners 230 (e.g., bolts, rivets, screws, etc.) to couple the top housing 218 to the bottom housing 222. As such, the top housing 218 may be removed from the bottom housing 222 to access the first end 166 of the cable 62. Specifically, a user can remove the top housing 218 from the bottom housing 222 to replace the cable 62. The top and bottom housings 218, 222 define a cable inlet 234, a cable outlet 238 opposite the inlet 234, and a reservoir 242 for oil between the cable inlet 234 and the cable outlet 238.

As shown in FIG. 8, the first end 166 of the cable 62 extends through the cable inlet 234, the reservoir 242, and the cable outlet 238 to define a cable axis 246. Although not shown, the cable oiling system 210 may include a lid or top to enclose and seal the reservoir 242 to the environment. The lid may be removable to allow a user to fill the reservoir 242 with oil. The reservoir 242 is configured to hold enough oil for at least five hours of operating the drain cleaning device 10. In some embodiments, the reservoir 242 may be able to hold up to ten ounces of oil.

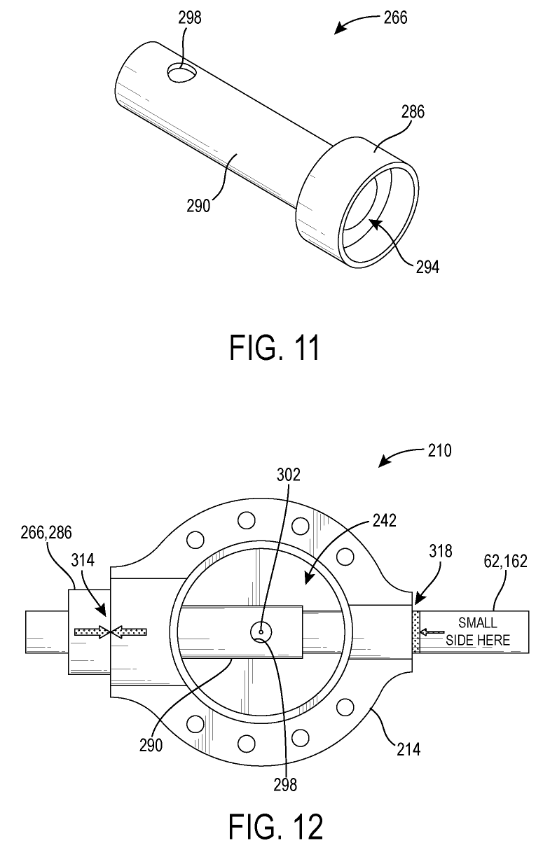

With reference to FIG. 9, the bottom housing 222 couples the cable oiling system 210 to the inner drum 54. The bottom housing 222 and the top housing define a valve seat 254 adjacent the cable inlet 234, a channel 258 adjacent the cable outlet 238, and a bottom surface 262 of the reservoir 242 between the cable inlet 234 and the cable outlet 238. The valve seat 254 receives a valve 266 (FIG. 11) as will be discussed in more detail below. The channel 258 receives a seal (e.g., an O-ring or other seal) to inhibit oil from leaking through the cable outlet 238. Channels 270 are defined on the flange 226 of the bottom housing 222 that correspond to channels (not shown) on the top housing 218. The channels 270 receive a gasket or chord stock to inhibit oil from leaking between the top and bottom housings 218, 222. The chord stock may be an oil-resistant material such as Buna-N cord stock. In the illustrated embodiment, the channels 270 are sized to receive a chord stock that is between 0.05 inches in diameter and 0.15 inches in diameter.

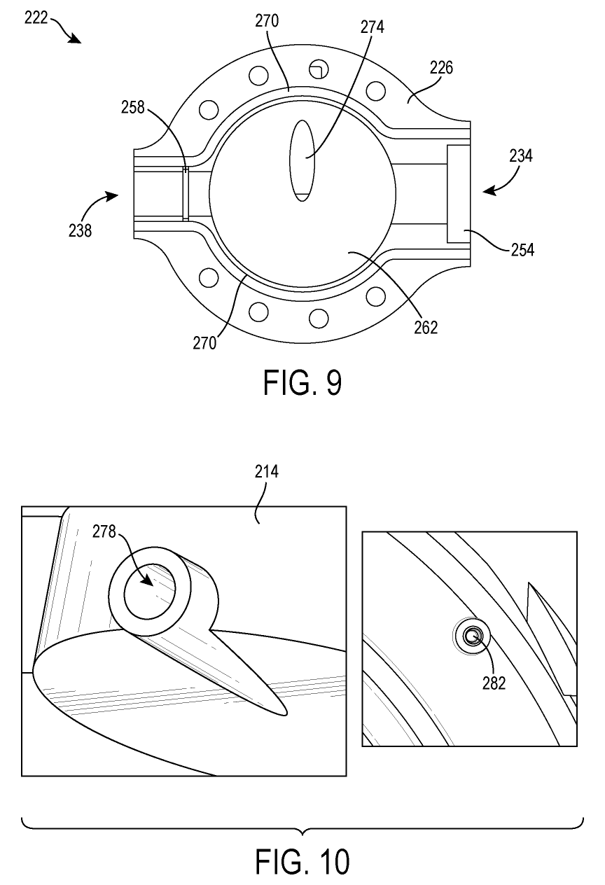

The bottom surface 262 of the reservoir is bowl-shaped so that the oil will flow down to a drainage hole 274 at an apex of the bottom surface 262. In other words, the bottom surface 262 is concave or semi-spherical. As shown in FIG. 10, the drainage hole 274 leads to an exterior of the housing 214 through a side outlet 278. The drainage hole 274 is configured to be covered with a plug 282. In some embodiments, the plug may be a threaded insert, such as a set screw. The plug 282 is removably coupled to the drainage hole 274 in order to empty the oil or replace the oil in the reservoir 242.

With reference to FIGS. 11 and 12, the valve 266 includes a first portion 286, a second portion 290 extending from the first portion 286, and a bore 294 extending centrally through the first and second portions 286, 290. The first and second portions 286, 290 are generally cylindrical with the second portion 290 including a smaller diameter than a diameter of the first portion 286. The second portion 290 includes a valve aperture 298 that corresponds to an aperture 302 in the sheath 162 of the cable 62. As shown in FIG. 8, the valve 266 is received in the valve seat 254 defined between the top and bottom housing 218, 222 with the second portion 290 of the valve 266 extending into the reservoir 242. The first portion 286 is positioned outside of the housing 214 and is accessible to a user. The cable 62 extends through the bore 294 of the valve 266 between the cable inlet 234 and the cable outlet 238. A first oil seal 306 (e.g., an O-ring, etc.) is positioned between the housing 214 and the valve 266. A second oil seal 310 (e.g., an O-ring, etc.) is positioned between the sheath 162 of the cable 62 and the valve 266. The oil seals 306, 310 assist in protecting the valve from the ingress of dirt and foreign materials and inhibits the egress of oil.

The valve 266 is movably (e.g., rotatably) received in the valve seat 254. In other words, the valve 266 is rotatable about the cable axis 246 between a first position, in which the valve aperture 298 is aligned with the aperture 302 in the sheath 162 such that the aperture 302 in the sheath 162 is exposed to oil within the reservoir 242, and a second position, in which the aperture 302 in the sheath 162 is covered by the second portion 290 of the valve 266 and not exposed to the oil in the reservoir 242. In other embodiments, the valve 266 may be linearly slidable relative to the valve seat 254 and along the cable axis 246 between the first and second positions. In further embodiments, the valve may be other manually or electronically actuated valves such as a ball valve or a gate valve. When the valve 266 is in the first position, oil is allowed to flow into the aperture 302 in the sheath 162 and into the space between the wound cable 158 and the sheath 162. When the valve 266 is in the second position, oil is inhibited from entering the aperture 302 in the sheath 162. The valve aperture 298 is generally larger than the aperture 302 in the sheath 162. In other words, the valve aperture 298 has a larger diameter than the aperture 302. In some embodiments, the cable oiling system 210 may include indicia 314 to indicate to a user the proper alignment of the valve aperture 298 with the aperture 302 of the sheath 162. For example, as shown in FIG. 12, the valve 266 may include an arrow that corresponds to an arrow on the housing 214 indicating that the apertures 298, 302 are properly aligned for oil to flow into the sheath 162. In addition, the cable oiling system 210 may include indicia 318 to indicate to a user the proper side of the housing 214 to position the valve 266 and run the cable 62.

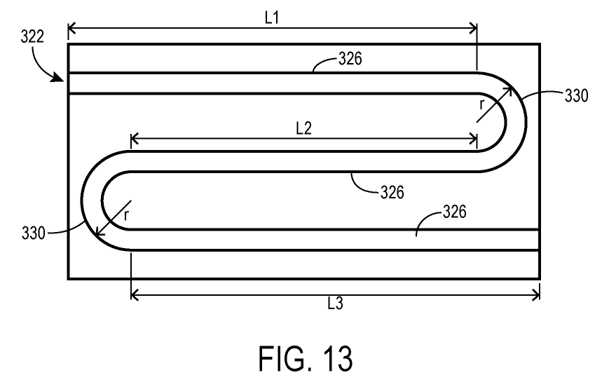

With reference to FIG. 13, the cable oiling system 210 may further define a passageway 322 to limit the flowrate of oil that is distributed into the sheath 162. The passageway 322 includes a series of linear sections 326 and cut-backs 330. Specifically, the passageway 322 includes three linear sections 326 separated by two cut-backs 330. In some embodiments, the passageway 322 defines a length of the passageway that is between 2.0 and 4.0 inches. The additional length to the flow path of the oil added by the passageway 322 decreases the overall flowrate of the oil from the reservoir 242 to inside the sheath 162. In the illustrated embodiment, the passageway 322 may be incorporated into the valve 266, the sheath 162, or may be a separate feature of the cable oiling system 210.

Before operating the drain cleaning device 10, in order to allow oil to enter within the sheath 162, a user may grasp and rotate the first portion 286 of the valve 266 from the second position to the first position to align the valve aperture 298 with the aperture 302 of the sheath 162. In other words, a user may rotate the valve 266 until the indicia 314 indicates to a user that the apertures 298, 302 are aligned. The user may then use the drain cleaning device 10 according to the operation discussed above. Due to the cable oiling system 210 supplying oil to the sheath 162 from the first end 166 of the cable 62, the motor 94 rotating the wound cable 158 forces the oil to flow from the first end 166 of the cable 62 to the second end 170 of the cable 62. After using the drain cleaning device 10, a user may then rotate the valve 266 from the first position to the second position to inhibit the egress of oil from the sheath 162 while the drain cleaning device 10 is being stored.

In some embodiments, the drain cleaning cable 62 may include a seal member attached at the ends 166, 170 of the cable 62 to inhibit liquids and other contaminants from entering or exiting the space between the wound cable 158 and the sheath 162. The seal member may include an attachment that couples to either end 166, 170 of the cable 62. For example, the attachment may include inner threads that thread onto the sheath 162 of the cable 62. A ring, such as an O-ring or an X-ring, may be positioned within the attachment to engage and form a seal with the wound cable 158.

Providing a cable oiling system 210 adjacent the motor driven end of a cable 62 eliminates the need to have the motor 94 rotate the wound cable 158 in both a forward and reverse direction. As such, the cable 62 remains lubricated while limiting wear on the cable 62. In addition, providing a housing 214 with a first housing 218 and a second housing 222 that is removable allows a user to easily access and replace the cable 62.

Although the invention has been described in detail with reference to certain preferred embodiments, variations and modifications exist within the scope and spirit of one or more independent aspects of the invention as described. For example, although the cable oiling system 210 is illustrated and described for use with the drain cleaning device 10, the cable oiling system 210 may also be used with other suitable drain cleaning devices having other configurations.

Various features of the disclosure are set forth in the following claims

What is claimed is:

1. A drain cleaning device comprising:
a frame;
a drum assembly supported by the frame, the drum assembly configured to rotate about an axis of rotation;
a motor supported by the drum assembly, the motor including an output shaft;
a flexible cable stored within the drum assembly, the flexible cable defining a first end, a second end opposite the first end, a sheath extending between the first end and the second end, and a wound cable positioned within the sheath, the first end coupled to the output shaft to receive torque from the motor, the first end including an aperture that extends into the sheath; and
a cable oiling system supported by the drum assembly adjacent the first end of the cable to supply oil to a space between the wound cable and the sheath through the aperture.

2. The drain cleaning device of claim 1, wherein the cable oiling system includes,
a housing defining a cable inlet, a cable outlet, and a reservoir between the cable inlet and the cable outlet, the reservoir configured to store oil, and
a valve supported by the cable inlet, the valve including a first portion that extends into the reservoir, the first portion including a valve aperture.

3. The drain cleaning device of claim 2, wherein the valve is movable from a first position, in which the valve aperture is aligned with the aperture of the cable to distribute oil to the space, and a second position, in which the valve aperture is not aligned with the aperture of the cable to inhibit the distribution of oil to the space.

4. The drain cleaning device of claim 2, wherein the cable extends through the valve.

5. The drain cleaning device of claim 2, wherein the housing includes a bottom housing portion and a top housing portion removably coupled to the bottom housing portion to allow access to the first end of the cable.

6. The drain cleaning device of claim 2, wherein the housing is coupled to the drum assembly.

7. The drain cleaning device of claim 2, wherein the housing includes a drainage hole to facilitate the drainage of oil from the reservoir.

8. The drain cleaning device of claim 1, wherein the drum assembly includes an inner drum, an outer drum, and a space defined therebetween, and wherein the cable is stored within the space.

9. The drain cleaning device of claim 1, wherein the drum assembly includes a closed rear end and an open front end opposite the rear end.

10. The drain cleaning device of claim 1, further comprising a cable guide housing that guides the cable from the motor to the drum assembly, wherein the cable oiling system is positioned between the motor and the cable guide housing.

11. A cable oiling system for a drain cleaning device including a flexible cable with a sheath and a wound cable positioned within the sheath, the cable oiling system comprising:
a housing defining a cable inlet, a cable outlet, and a reservoir therebetween, the reservoir configured to store oil; and
a valve supported by the cable inlet, the valve including a first portion, a second portion extending from the first portion and into the reservoir, and a bore extending between the first and second portions, the flexible cable configured to extend through the cable inlet, the cable outlet, and the bore;
wherein the valve is moveable from a first position, in which oil is distributed to the wound cable from the reservoir, and a second position, in which the distribution of oil from the reservoir to the wound cable is inhibited.

12. The cable oiling system of claim 11, wherein the valve is rotatable between the first and second positions.

13. The cable oiling system of claim 12, wherein the first portion of the valve is positioned outside of the housing and accessible to a user to rotate the valve from the first position to the second position.

14. The cable oiling system of claim 11, wherein the first portion of the valve includes indicia that corresponds to indicia on the housing to indicate that the valve is in the first position.

15. The cable oiling system of claim 11, wherein the sheath includes an aperture, wherein the second portion of the valve includes a valve aperture, and wherein when the valve is in the first position the valve aperture is aligned with the aperture of the sheath to distribute oil to the wound cable.

16. The cable oiling system of claim 15, wherein the valve aperture is larger than the aperture.

17. The cable oiling system of claim 11, wherein the housing includes a bottom housing portion and a top housing portion removably coupled to the bottom housing portion to allow access to the cable.

18. The cable oiling system of claim 17, wherein the bottom housing and the top housing define a valve seat adjacent the cable inlet that receives the valve.

19. The cable oiling system of claim 11, further comprising an oil seal positioned between the valve and the housing to inhibit the egress of oil.

20. The cable oiling system of claim 11, wherein the housing includes a drainage hole to allow drainage of oil from the reservoir.
